(19) United States
(12) Patent Application Publication
(10) Pub. No.: US 2007/0266940 A1
(43) Pub. Date: Nov. 22, 2007

(54) Chemical dispensing control device of a photo spinner

(76) Inventor: Min-Kyu Choi, Seoul (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/637,790

(22) Filed: Dec. 13, 2006

(30) Foreign Application Priority Data
May 22, 2006 (KR) 2006-0045475

(51) Int. Cl. B05C 13/02; B05C 11/00

(52) U.S. Cl. 118/708; 118/663; 118/52

(57) ABSTRACT

A chemical dispensing control device capable of indicating an open/closed position of a drain valve and generating an interlock signal when the drain valve is opened in a chemical coating process is disclosed. The chemical dispensing control device for use in a photo spinner to alarm and generate an interlock signal in case the drain valve is not closed in a spin coating process includes a variable resistance for detecting a voltage corresponding to a change of resistance value based on an open/close position of said drain valve and a controller for receiving the detected voltage, determining an open/close position of the drain valve, and generating an interlock signal when the closed position of the drain valve is not detected during the coating process.

### BACKGROUND OF THE INVENTION

1. Field of the Invention

Embodiments of the invention relate to photo spinners used in semiconductor manufacturing and more particularly to a chemical dispensing control device capable of indicating an open/close state of a drain valve and generating an interlock signal when the drain valve opens during a chemical coating process.

This application claims priority under 35 U.S.C. §119 from Korean Patent Application 10-2006-0045475, filed on May 22, 2006, the entire contents of which are hereby incorporated by reference.

2. Discussion of Related Art

The fabrication of semiconductor devices generally includes the steps of deposition, photolithography, etching and implantation. The deposition step forms a processing layer (SiO2) on a semiconductor substrate or wafer. In the photolithography step, a pattern is imaged onto the substrate via a mask or reticle that is at least partially covered by a layer of radiation-sensitive material known as a photoresist. The etching step is used to etch away that portion of the processed layer no longer protected by the photoresist. The photolithography process is performed in a semiconductor manufacturing device called a spinner or an exposure apparatus. Chemicals are applied onto an oxide layer and then a high speed rotation is applied thereto to form a uniform coating layer. The thickness of the chemical coated on a wafer determines the precision level of critical dimension (CD) of a circuit.

A device to uniformly coat a wafer with photoresist is disclosed in U.S. Pat. No. 6,332,924 B1 which discloses that a wafer may be uniformly coated with photoresist with a constant discharge amount and pressure through a nozzle. A conventional photoresist supply device may include a plurality of photoresist bottles. When photoresist contained in one bottle is completely used, the empty bottle may be replaced with another filled bottle in order to fill a supply line with photoresist. FIG. 1 is a block diagram of a conventional chemical supply device. First and second chemical bottles 1 and 2 store the same kind of chemical solution. First and second gas supply lines 11 and 12 are connected to first and second chemical bottles 1 and 2 to supply purge gas N2. First and second gas supply valves 13 and 14 are installed on first and second gas supply lines 11 and 12 and open/close to supply or cut-off purge gas N2. First and second chemical supply lines 15 and 16 are installed in first and second chemical bottles 1 and 2. First and second trap tanks 3 and 4 are connected to first and second chemical supply lines 15 and 16 to receive and store chemical supplied from first and second chemical bottles 1 and 2. First and second bottle exchange valves 7 and 8 are each connected to first trap tank 3 and second trap tank 4 and open/close to discharge the chemical solution. A third chemical supply line 17 is connected to first and second bottle exchange valves 7 and 8 to supply the chemical to nozzle 18 via first and second bottle exchange valves 7 and 8. Nozzle 18 sprays the chemical supplied through chemical supply line 17 to wafer 10.

First and second discharge lines 21 and 22 are connected to the upper portions of first and second trap tanks 3 and 4 to discharge chemical stored in these tanks. First and second drain valves 5 and 6 are installed along first and second discharge lines 21 and 22 and open/close to discharge the chemical solution. Drain tank 9 is connected to first and second discharge lines 21 and 22 and stores discharged chemical solution as well as discharged bubbles/gases.

An operator opens second drain valve 6 and second gas supply valve 14 to access chemical solution stored in second bottle 2. Purge gas N2 is supplied through second gas supply line 12 to pressurize chemical bottle 2. The chemical solution fills second trap tank 4 through second chemical supply line 16 and is discharged with its associated bubbles/gas to drain tank 9 through second discharge line 22. When trap tank 4 is filled, the operator closes second drain valve 6 to complete the chemical setting.

FIG. 2 is a perspective view illustrating an external structure of the first and second drain valves 5 and 6 shown in FIG. 1. Second drain valve 6 may be closed by rotating a control knob 19 clockwise (CW) and may be opened by rotating it counterclockwise (CCW). First bottle exchange valve 8 is then opened and chemical solution stored in second trap tank 4 is supplied to nozzle 18 via third supply line 17 and chemical solution is sprayed on wafer 10 by using a dispense pump (not shown) in a coating process. During the coating process, chemical solution stored in second tank 2 is consumed and the operator opens first drain valve 5 and second gas supply valve 13. In this manner purge gas N2 is supplied through first gas supply line 11 to pressurize first bottle 1 and chemical solution stored in first chemical bottle 1 is supplied to first trap tank 3 through first chemical supply line 15, thereby filling first tank 3. The chemical solution filled in first trap tank 3 is discharged (including associated bubbles) to drain tank 9 via first discharge line 21. When the chemical solution fills first trap tank 3, the operator closes first drain valve 5 which completes the chemical setting. The first drain valve 5 may be closed by rotating control knob 19 CW and may be opened by rotating it CCW. The chemical solution stored in first trap tank 3 is sprayed on wafer 10 via nozzle 18 by opening first bottle exchange valve 7.

A drawback associated with the above conventional chemical supply device is that it is difficult to monitor whether or not first and second drain valves 5 and 6 are opened or closed. If an operator mistakenly does not close a drain valve, the chemical solution cannot be sprayed on a wafer which may cause coating defects. In addition, because it takes about 4-5 hours to trace and process a wafer lot, a large number of wafers may have already undergone the coating process resulting in wasted time, materials and associated expense. Accordingly, there is a need for a chemical dispensing control device for use in a semiconductor photo spinner which is capable of alarming and generating an interlock when a drain valve is not closed during a spin coating process.

### SUMMARY OF THE INVENTION

Exemplary embodiments of the present invention are directed to a chemical dispensing control device for use in a photo spinner having a drain valve to perform an opening/closing operation so that bubbles associated with a chemical solution are removed. The device includes a variable resistance for detecting a voltage corresponding to a change of resistance value associated with an open or close position of a drain valve and a controller for receiving the detected voltage and determining an open or closed position of the drain valves and generating an interlock signal when the drain valve is not closed during a coating process. An LED may also be included to indicate the position of the drain valve (opened/closed) with a particular color in response to an LED drive control signal from the controller.

### BRIEF DESCRIPTION OF THE DRAWINGS

FIG. 1 is a block diagram of conventional chemical supply device;

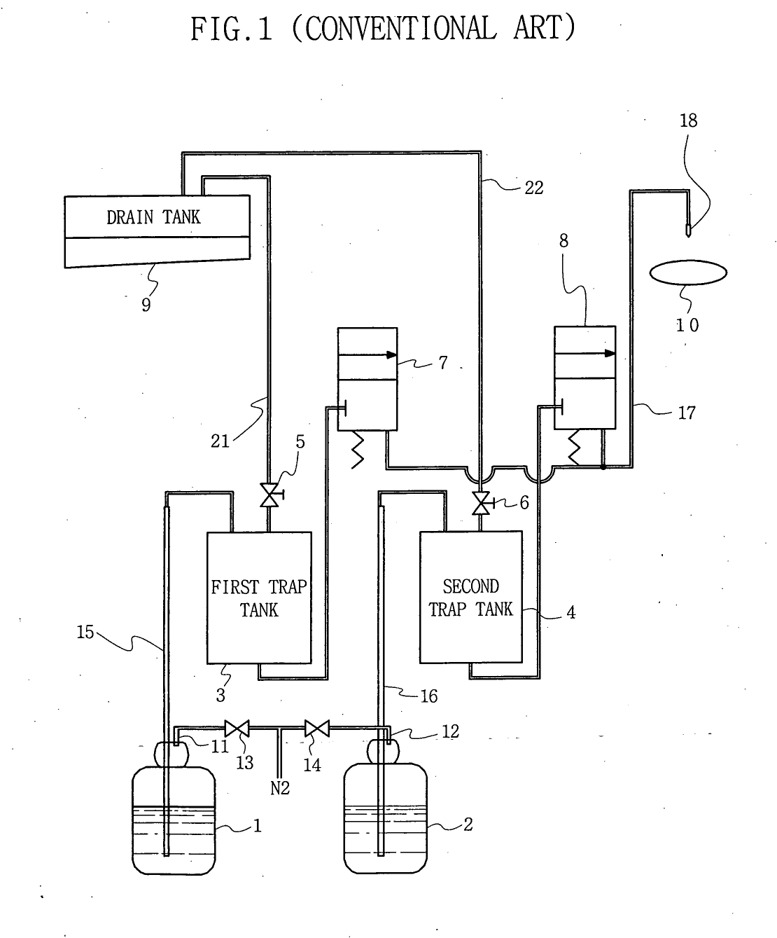

FIG. 2 is a perspective view illustrating an external structure of the first and second drain valves shown in FIG. 1;

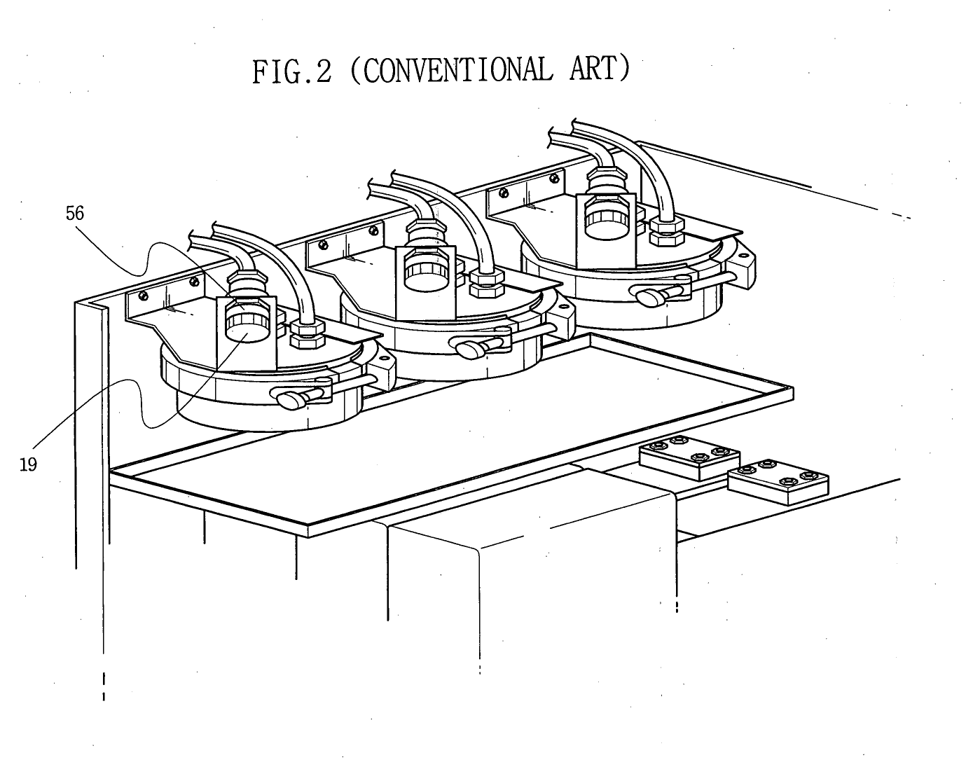

FIG. 3 illustrates a configuration of a chemical supply device for use in a semiconductor coating apparatus in accordance with the present invention;

FIG. 4A illustrates a closed state of first and second drain valves shown in FIG. 3;

FIG. 4B illustrates an opened state of the first and second drain valves shown in FIG. 3; and

FIG. 5 is a flowchart illustrating a generation of interlock when a drain valve is opened in a coating process in accordance with the present invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

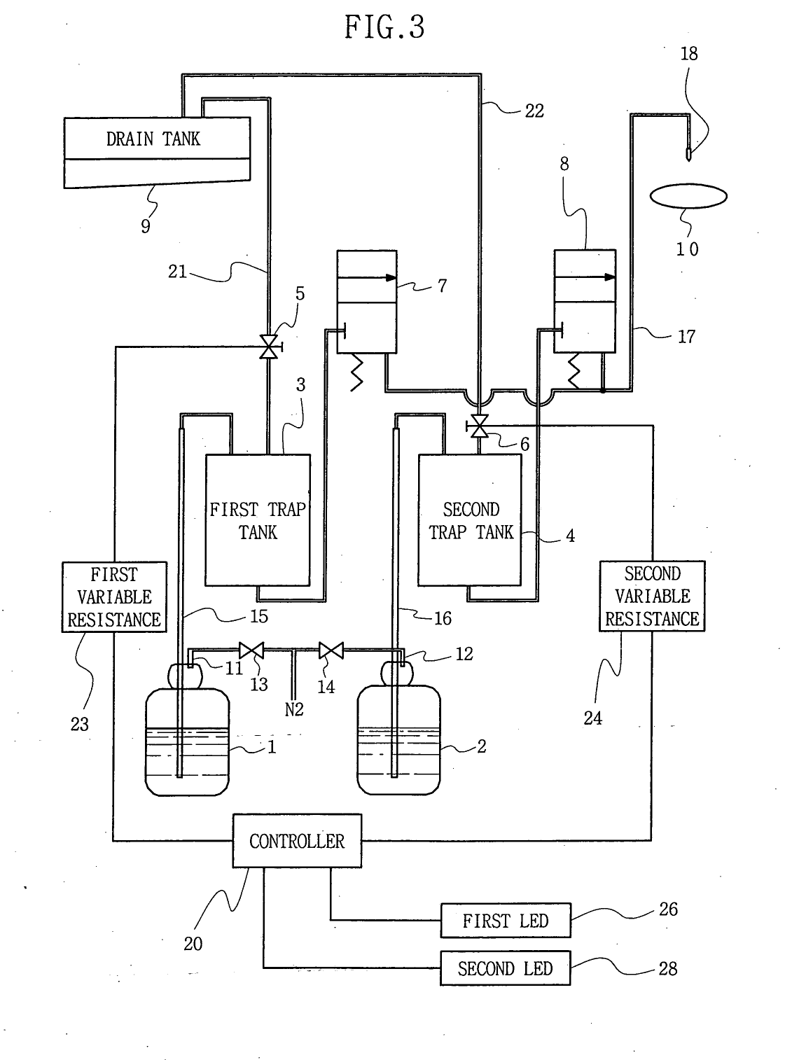

FIG. 3 illustrates a configuration of a chemical supply device for use in a semiconductor coating apparatus according to an embodiment of the invention. First and second chemical bottles 1 and 2 store a chemical solution. First and second gas supply lines 11 and 12 are disposed between first and second chemical bottles 1 and 2 and supply purge gas N2. First and second gas supply valves 13 and 14 are positioned on first and second gas supply lines 11 and 12 and open/close to supply or cut-off purge gas N2 to bottles 1 and 2. First and second chemical supply lines 15 and 16 supply chemical from first and second chemical bottles 1 and 2 to first and second trap tanks 3 and 4. First and second bottle exchange valves 7 and 8 are each connected to first and second trap tanks 3 and 4 and open/close to discharge or prevent the discharge of chemical solution. A third chemical supply line 17 is connected with first and second bottle exchange valves 7 and 8 and supplies chemical to nozzle 18 via first and second bottle exchange valves 7 and 8. A nozzle 18 sprays the chemical supplied through third chemical supply line 17 to wafer 10. First and second discharge lines 21 and 22 are connected at a first end to the upper portions of first and second trap tanks 3 and 4 and discharge chemical stored in first and second trap tanks 3 and 4. First drain valve 5 is disposed along first discharge line 21 and opens/closes to discharge or cut-off discharge of the chemical solution to drain tank 9. Second drain valve 6 is disposed along second discharge line 22 and opens/closes to discharge or cut-off discharge of the chemical solution to drain tank 9.

The drain tank 9 is connected to first and second discharge lines 21 and 22 and stores the chemical (including discharge bubbles) received from tanks 3 and 4. First variable resistance detector 23 connected to first drain valve 5 and second variable resistance detector 24 connected to second drain valve 6 each detect a voltage corresponding to a change of resistance corresponding to a rotation of the respective knobs on first and second drain valves 5 and 6. Controller 20 receives voltage detected by first and second variable resistances 23 and 24 and determines if the respective drain valves 5 and 6 are in an open or close position. Controller 20 also outputs an LED drive control signal corresponding to the open/close position and also generates an interlock signal when a closed position associated with both the first and second drain valves 5 and 6 is not detected during a semiconductor coating process. First LED 26 indicates the open/close position of the first and second drain valves 5 and 6 with a particular color in response to LED drive control signal from controller 20. Second LED 28 indicates a power supply state with a particular color in response to the LED drive control signal from controller 20.

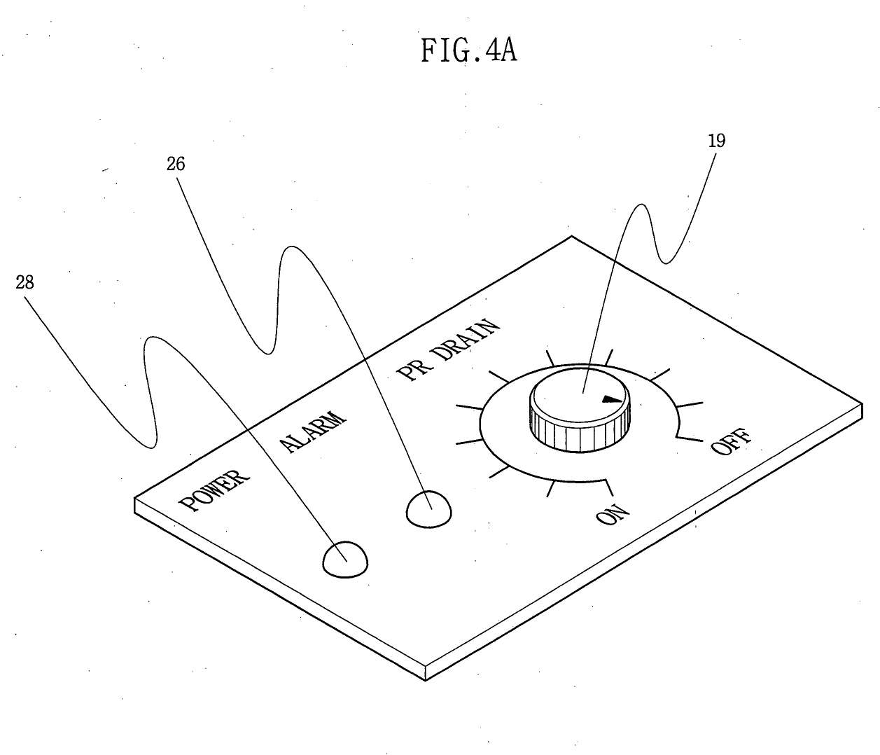

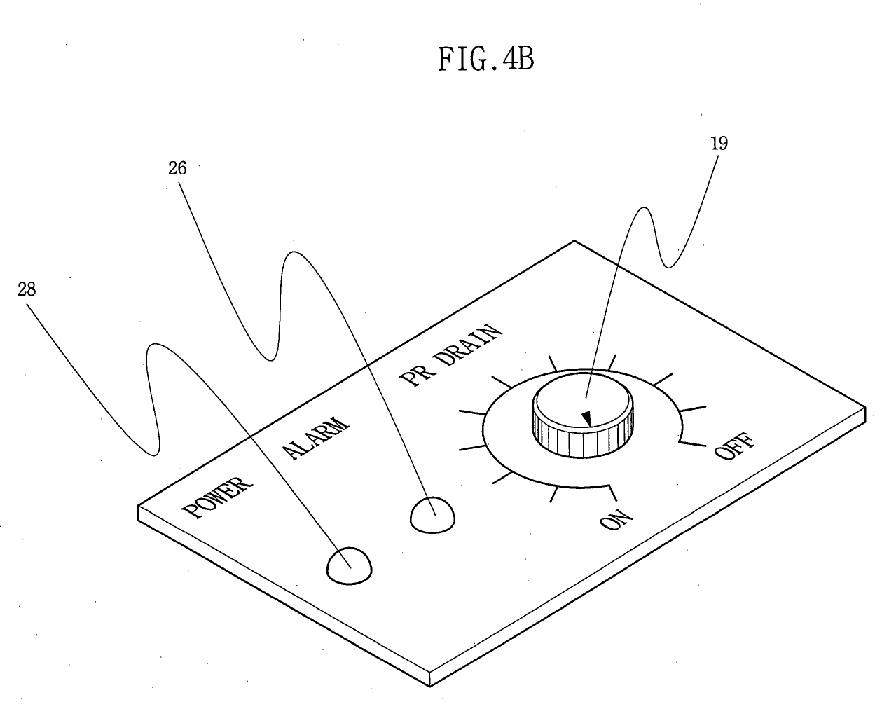

FIG. 4A illustrates an example of an indicator panel including first LED 26, second LED 28 and control knob 19 in an off position. FIG. 4B illustrates an example of an indicator panel including first LED 26, second LED 28 and control knob 19 in an on position. In operation and referring to FIGS. 3, 4A and 4B, an operator opens second drain valve 6 and second gas supply valve 14. Purge gas N2 is supplied through second gas supply line 12 to pressurize the second chemical bottle 2, and then the chemical solution is filled in second trap tank 4 through second chemical supply line 16. The chemical solution filled in second trap tank 4 is discharged (including associated bubbles) to drain tank 9 through second discharge line 22. When trap tank 4 is filled with chemical solution, the operator closes second drain valve 6 to complete the chemical setting. Second drain valve 6 may be closed by rotating control knob 19 shown in FIG. 4A CW and may be opened by rotating it CCW. First bottle exchange valve 8 is opened and chemical solution stored in second trap tank 4 is supplied to nozzle 18 through third supply line 17 and chemical solution is sprayed to wafer 10 by using a dispense pump(not shown). During the coating process, chemical solution stored in second trap tank 2 is consumed and the operator opens first drain valve 5 and second gas supply valve 13 to access purge gas N2 via chemical bottle 1 supplied through first gas supply line 11. The chemical solution stored in first chemical bottle 1 is supplied to fill first trap tank 3 through first chemical supply line 15. The chemical solution filled in first trap tank 3 is discharged (including associated bubbles) to drain tank 9 through first discharge line 21. When the first trap tank 3 is filled with the chemical solution, the operator closes first drain valve 5 thereby completing the chemical setting. First drain valve 5 may be closed by rotating control knob 19 CW and may be opened by rotating control knob 19 CCW. The chemical solution stored in first trap tank 3 is supplied to nozzle 18 by opening first bottle exchange valve 7 such that the chemical solution may be sprayed on wafer 10.

Wafer 10 is coated with the chemical solution through the operation described above and the operator opens first drain valve 5 or second drain valve 6 to remove the associated bubbles. In the event that the operator does not close first or second drain valves 5 or 6 as shown in FIG. 4A, first LED 26 indicates a first particular color, for example red, and second LED 28 indicates a second particular color, for example, green. However, if the operator opens first or second drain valve 5 or 6 to remove the associated bubbles and then closes a valve after removing the bubbles as shown in FIG. 4B, first LED 26 and second LED 28 indicate.

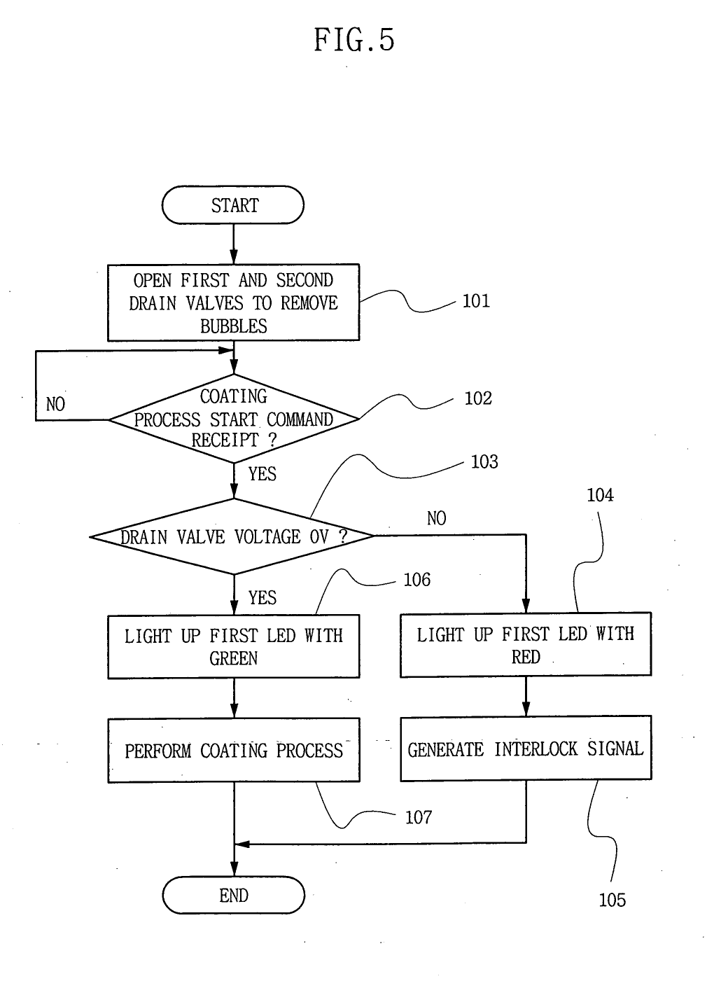

FIG. 5 is a flowchart illustrating the generation of an interlock signal when a drain valve 5 or 6 is opened in a coating process. When an operator rotates knob 19 of first or second drain valves 5 or 6 CCW in step 101, first or second drain valve 5 or 6 is opened and a voltage (e.g. 5V) is supplied to first or second variable resistance 23 or 24. Controller 20 senses the voltage of first or second drain valves 5 or 6 and lights up first LED 26 with the color red and second LED 28 with the color green. At this time, first drain valve 5 or second drain valve 6 is opened and bubbles generated in first or second trap tank 3 or 4 are discharged to drain tank 9. Once the bubbles are removed, controller 20 checks whether a coating process start command has been received at step 102. When this start command is received, controller 20 checks, at step 103, whether a voltage of first or second variable resistances 23, 24 of first or second drain valves 5, 6 is at 0V. If the voltage is not detected as 0V, at step 104 controller 20 lights up first LED 26 with the color red. In step 105, controller 20 generates an interlock signal to stop the coating process and operation of the process equipment. If the voltage detected at step 103 from first or second variable resistances 23, 24 of first or second drain valves 5, 6 is not 0V (e.g. 5V), first or second drain valves 5, 6 is determined to be in a closed position. In step 106, controller 20 lights up first LED 26 with green and controller 20 operates the process equipment to perform the coating process at step 107.

In this manner, an interlock signal may be used to stop an operator of semiconductor manufacturing equipment if a drain valve mistakenly remains open when a coating process start command is received by controller 20. By stopping the process equipment, wafer fabrication errors caused by the absence of chemical solution resulting in no process patterns is avoided. In addition, time required to trace and process wafer lots may be prevented thereby increasing productivity and reducing associated time and material costs.

Although the present invention has been described in connection with the embodiments illustrated in the accompanying drawings, it is not limited thereto. It will be apparent to those skilled in the art that various substitution, modifications and changes may be thereto without departing from the scope and spirit of the invention.

What is claimed is:

1. A chemical dispensing control device for use in a photo spinner having a drain valve to perform an opening/closing operation to remove bubbles associated with a chemical solution, the device comprising:
a variable resistance for detecting a voltage corresponding to a change of resistance value associated with an open or close position of said drain valve; and
a controller for receiving the detected voltage and configured to determine an opened or closed position of said drain valves and generating an interlock signal when said drain valve is not closed during a coating process.

2. A chemical dispensing control device for a photo spinner having a drain valve to perform an opening/closing operation to remove bubbles associated with a chemical solution, the device comprising:
a variable resistance detector for detecting a voltage corresponding to a change of resistance value associated with an open or close position of said drain valve;
a controller for receiving said detected voltage and configured to determine an open or closed position of said drain valve, said controller outputting an LED (Light Emitting Diode) drive-control signal corresponding to the position of said drain valve and generating an interlock signal when an open state of said drain valve is detected during a coating process; and
an LED for indicating the opened or closed position of said drain valve with a particular color in response to said LED drive control signal from said controller.

3. The device of claim 2 wherein said LED is a first LED and said particular color is a first particular color, said device further comprising a second LED for indicating a power supply state with a second particular color in response to the LED drive control signal from said controller.

4. The device of claim 3, wherein said first particular color is red corresponding to said open position of said drain valve.

5. A chemical dispensing control device of a photo spinner, comprising:
first and second chemical bottles for storing the same type chemical solution;
first and second gas supply lines coupled to said first and second chemical bottles to supply N2 purge gas;
first and second gas supply valves installed along said first and second gas supply lines to perform opening/closing operation to supply or cut off, respectively, the N2 purge gas;
first and second trap tanks for storing said chemical solution supplied from said first and second chemical bottles;
a nozzle for spraying said chemical solution supplied from said first and second trap tanks to a wafer;
first and second drain valves for performing an opening/closing operation to allow or cut-off discharge of bubbles associated with said chemical solution generated in said first and second trap tanks;
a drain tank for storing said chemical solution, including bubbles, discharged through said first and second drain valves;
first and second variable resistances for detecting a voltage corresponding to a change of resistance based on rotation of a knob associated with each of said first and second drain valves;
a controller for receiving said detected voltage and configured to determine an open or closed position-of said first and second drain valves, said controller outputting an LED drive control signal corresponding to the position of said drain valves and generating an interlock signal when said first and second drain valves are not detected as closed during a coating process; and
a first LED for indicating the open and closed position of said first and second drain valves with a particular color in response to said LED drive control signal from said controller.

6. The device of claim 5, further comprising a second LED for indicating a power supply state with a particular color in response to said LED drive control signal from said controller.

7. The device of claim 6, wherein said first particular color is red corresponding to said open position of said drain valve.
